(19) United States
(12) Patent Application Publication
(10) Pub. No.: US 2018/0272928 A1
(43) Pub. Date: Sep. 27, 2018

(54) Intelligent Lighted Saftey Helmet

(71) Applicant: Brad Boksteyn, Sylvan Lake (CA)

(72) Inventor: Brad Boksteyn, Sylvan Lake (CA)

(21) Appl. No.: 15/530,925

(22) Filed: Mar. 23, 2017

(51) Int. Cl. B60Q 1/26; A42B 3/04; A42B 3/06; A42B 3/12; B60Q 1/44; B60Q 1/00

(52) U.S. Cl. CPC B60Q 1/2676; A42B 3/0453; A42B 3/062; A42B 3/125; B60Y 2200/20; B60Q 1/0023; B60Y 2200/12; B60Y 2200/13; B60Q 1/44

(57) ABSTRACT

A helmet shaped to fit the human head designed to provide protection against impact and provide a holder for various safety lights. The purpose of these lights being to warn other of the wearer's presence and movement intentions.

### FIELD OF THE INVENTION

The present invention relates to an Intelligent Lighted Safety Helmet and, more particularly, to safety helmet equipped with running lights and speed indicator lights that warns those vehicles following the wearer of this helmet that the wearer is slowing down or stopping. A helmet used for ATV's, UTV's. motorcycles, bicycles and other associated type conveyances.

### BACKGROUND OF THE INVENTION

Description of the problem—The first problem is one of visibility. Other drivers especially those in automobiles and trucks often do not see a rider of a motorcycle, bicycle, ATV or other such conveyance in the dark because of poor lighting. Bicycles and off-road vehicles may not have any lights at all while motorcycles may have one light that is placed low, below the hood height of the following vehicle or inadvertently dimmed due to dirt of a covering. Riders are often young and inexperienced and don't concern themselves with safety not realizing they are difficult for other vehicles to see. In other situations, they may be equipped with running lights but no lights indicating they are slowing or stopping failing to warn the following conveyance of an impending speed change causing the following conveyance to run into or over them!

Riders do not realize they are being followed as closely as they are and when riding off-road on trails there are many sudden turns, dips obstacles that can create an emergency stop or dramatic slowdown situation causing the rider to “hit” the breaks. By the time the follower realizes that the person ahead has made a sudden speed change they have closed the distance and cannot stop in time.

In other situations, the rider is simply not visible I the dark. They often wear dark or drab clothing and have poor or no lighting. Even if they have lighted this lighting is typically small tail lights that are not visible from the side or often not visible from the rear because of their low position. Research data has revealed that, while nearly half (45%) of bikers will initially spend more than $200.00 to purchase a safe helmet, safety is being compromised when choosing the style of helmet.

Four in ten (38%) motorcyclists said they chose a fashionable—but hard to spot—black as their helmet color, ahead of more visible options such as blue (14%) and yellow (6%). Thus, we see that riders do not place importance on viability for their own safety.

All or any one of these problems can cause serious injury or death to one or more people.

Other Solutions exist in the way of lights and reflectors mounted on the conveyance, reflective clothing and even clothing with some sort of lighting.

Other helmets exist.

Shortcomings of Other Solutions: Conveyance Lights are often small, placed low, get dirty and are generally difficult to see in many situations. Often the lights are simply running lights and do not indicate a stopping or slowing of the conveyance permitting a follower to react in time to avoid a collision.

Lights are often not placed on the sides so a follower encountering a conveyance at a T or crossroads type intersection may not be able to see the rider they are encountering until it is too late.

Reflective clothing loses its reflective properties in time, can get dirty and has only a short range or limited use.

Lighted clothing tends to use very small LED type lighting and can be confusing to another driver slowing reaction time.

Other helmets do not allow for an intelligently controlled speed change indicator. Sudden speed change is one of the biggest factors in collisions from following conveyances.

is, therefore, the purpose of this invention to provide a comfortable protective covering to reduce or eliminate injury to the wearer's head.

It is further the purpose of this invention to provide a G force activated light that will indicate when a rapid slowing or stopping of the wearer occurs in automatic relation to that de-acceleration occurrence.

It is a further purpose of this invention to provide a visual safety light at the height of the wearer's head to make it more visible to any following convenience by both placing at eyesight level and raising it above terrain and other obstructions.

It is yet another purpose of this invention to provide circumferential lighting for greater visibility of the wearer in all directions.

It is still another purpose of this invention to provide an energy means of a battery or solar power to meet the various needs and conditions that wearers will offer.

### SUMMARY OF THE INVENTION

In accordance with the present invention, there is provided a helmet shaped to fit the human head designed to provide protection against impact and serve as a carrier for various safety lights. The purpose of these lights being to warn other of the wearer's presence and movement intentions.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a helmet showing the logo cover, LED light bar, led light control pack where it is situated and how it is attached.

For purposes of clarity and brevity, like elements and components will bear the same designations and numbering throughout the Figures.

### DESCRIPTION OF THE PREFERRED EMBODIMENT

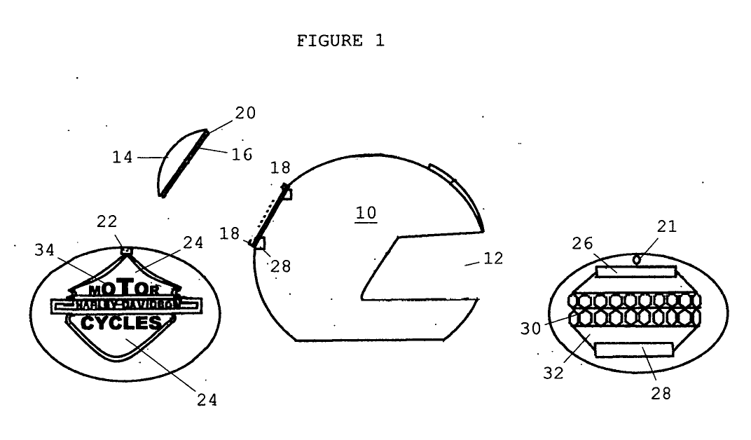

FIG. 1 is a view of a helmet 10 containing the safety features provided by the most preferred example of the present invention.

In accordance with the present invention, there exists a helmet 10 designed for riding conveyances such as motorcycles, ATV's, UTV's, Snowmobiles, boats, bicycles and other conveyances where the rider may or may not be completely enclosed. But where the riders rear helmet 10 may be seen by those following in similar or dissimilar conveyances. The helmet 10 is general constructed to fit the head of a human head adult or child with a certain size and other modifications to adapt to the particular wearer but being generally the same as all human heads.

Various materials can be used to create a helmet 10 and the type of material used affects various aspects of that helmet 10. We will now describe some of the preferred materials but understand we are not limiting the present invention to these materials. Any rigid yet impact resistant material suitable for helmet 10 production may be utilized in the present invention. We merely list several examples her to provide the reader with a better understanding of the goals and purpose and how those may be adjusted to meet various needs. A helmet 10 made of: a shell, a foam layer, and padding. The shell disperses the impact across a wide area while also preventing anything from piercing the helmet 10. Meanwhile, the foam absorbs as much of the impact as possible, so your head doesn't have to. Lastly, the soft padding ensures a good fit against your head.

The difference between basic and advanced helmets normally lies in the shell. In contrast, a wide variety of helmets will employ very similar foam layers. Most use some variation of EPS—expanded polystyrene foam. This stuff is stiff and lightweight, but also perfectly crushable during impact. Some advanced helmets will use multiple densities of EPS in various layers and locations. This creates a smarter helmet 10, which can absorb the crash differently depending on the severity and location of impact. Thermoplastic Shells.

Thermoplastic is exactly what it sounds like—hot plastic. That means it can be poured into a mold and cooled into a solid shell. The plastic is usually some form of polycarbonate, which isn't the hardest material out there. So, these helmets require more foam padding to meet safety standards. For this reason, thermoplastic helmets are larger and heavier than more advanced helmets. ‘However, they are also cheap and easy to make. This is, therefore, the cheapest option.

Fiberglass shells are more expensive than plastic, mainly because they're a pain in the butt to make. You have to place fiber cloth inside a mold, add a resin, and then heat everything to a billion degrees. Then, you repeat this process over and over to achieve a weave pattern.

At the end of all this, you have a shell that is harder and more lightweight than plastic. It also has a good impact flexibility, which spreads the force over a wider area of EPS foam. Fiberglass quite brittle and prone to cracking. So, you'll have to be extra careful not to drop one of these helmets. However, a crackling helmet 10 is great in a crash, because the shell will absorb much of the force before the foam layer even comes into play. So, fiberglass helmets don't require as much foam padding, making them smaller and lighter than plastic lids.

Advanced Fiberglass Shells: These are similar to fiberglass shells. However, they are made from advanced fibers that have already been mixed with a resin or some other substance. So, there's often no need for multiple layering steps. The manufacturing process is, therefore, simplified, which results in a perfect material balance. The result is a helmet 10 with all the same safety features as regular fiberglass, at about 80% the weight.

Kevlar and Carbon Composite Shells: A Kevlar shell has some distinct benefits. The process is the same as with fiberglass but, instead of using fiber cloth or Aramid, manufacturers use Kevlar. And since Kevlar is strong, you don't need to use as many fibers to achieve the same result. So, Kevlar composite shells can be about 20% lighter than fiberglass shells.

Notice the word composite? It's there because Kevlar—which has an awesome tensile strength—kind of blows in terms of compression strength. So, helmets always combine Kevlar with some other material to make up for its shortcomings. Most often, you'll see carbon fiber filling this role. Carbon fiber is super strong and lightweight. It's also very expensive, but since Kevlar isn't cheap to begin with, who cares? The result is a top-of-the-line shell, which achieves the safety standards of fiberglass and plastic helmets with much less size and weight.

The important thing to remember is that advanced materials do not imply advanced safety; a plastic lid can be just as safe as some space-age helmet 10. The difference is that the plastic model uses more volume and weight to achieve the same results. If you're going down, there won't be much difference between the two. When you're riding, however, your neck will thank you for a lighter helmet 10.

By the very nature of a safety helmet 10, the standards will vary according to the purpose, such as require fire retardant in racing but not other fields, a country where it is being used and so forth. Because of these varying standards and requirements, the present invention must remain flexible in its construction and materials, therefore, no one specific material or standard is claimed. To further demonstrate the validity of this, claim the DOT and UK standards have been listed here in part as well as who and how helmets are tested and certified:

DOT, ECE 22.05 & Snell Motorcycle Helmet 10 Standards.

There are more than the three standards that we'll cover here, but these are the ones you are most likely to see: DOT, ECE 22.05 and Snell.

We don't assume that one standard is superior to any of the others; rather the purpose is to show how the standards compare and where they apply. These motorcycle helmet 10 standards are not mutually exclusive; some helmets are certified to multiple standards.

Following is an explanation of each helmet 10 standard.

DOT Helmet 10 Standard:

This stands for “Department of Transportation,” is FMVSS 218, the Federal Motor Vehicle Safety Standard #218, Motorcycle Helmets, and it is applicable to helmets sold in the U.S. for on-road use.

The National Highway Safety Administration (NHTSA) enforcement authority of the DOT certification requirement applies to helmets intended for on-road use though using a certified helmet 10 for off-road purposes or in competition is certainly a good idea.

NHTSA does not test helmets against the DOT standards before they can claim DOT certification; rather, each helmet 10 manufacturer marketing their helmets for road use in the U.S. must test and self-certify the models they want to sell and then permanently affix the “DOT” emblem signifying compliance with FMVSS 218.

NHTSA enforces the standard by acquiring random samples of the product and sending them to an independent testing lab to verify compliance. Penalties to manufacturers for marketing non-compliant products can be steep-up to $5,000 per helmet 10.

FMVSS 218 sets standards in three areas of helmet 10 performance: impact attenuation, basically energy absorption; penetration resistance; and finally, the retention system effectiveness, and there are new product labeling requirements.

The standard also requires peripheral vision to be not less than 105° from the helmet 10 midline. Projections from the surface of the helmet 10 (snaps, rivets, etc.) may not exceed 5 mm.

The impact test measures acceleration of a head form inside the helmet 10 when it is dropped from a fixed height onto a spherical and flat surfaced anvil. The standard allows a peak acceleration energy of 400 G (G being “gravity constant” or an acceleration value of ft. per second x seconds).

The penetration test involves dropping a piercing test striker onto the helmet 10 from a fixed height. The striker must not penetrate deep enough to contact the head form.

The retention system test involves placing the helmet's retention straps under load in tension. For this test the load is progressive; first, a load of 22.7 kg (49.9 lb.) is applied for 30 seconds, then it is increased to 136 kg (299.2 lb.) for 120 seconds, with measurement of the stretch or displacement of a fixed point on the retention strap from the apex of the helmet 10.

The apparatus for testing a helmet 10 retention system under DOT (FMVSS 218) standards.

ECE 22.05 Helmet 10 Standard:

ECE stands for “Economic Commission for Europe,” which was created under a United Nations agreement in 1958. The 22.05 part refers to the specific regulation that the standards for testing are described in.

The ECE standard, which is accepted in 47 countries, is similar to the DOT standard in several ways, for example: like the DOT standard, peripheral vision through an arc of 105° from the helmet 10 midline is required. Also, environmental conditioning of helmets to be tested is required similar to the DOT standard and certain labeling requirements apply, as well.

Impact absorption testing is performed in a manner very similar to the DOT standard, involving a drop test from a fixed height on a steel anvil with a head form-fitted inside to measure the energy transmitted. Peak acceleration energy at the head form allowed to pass the test is 275 G. Impact absorption and rotational forces are also tested at points where any surfaces or parts project from the shell of the helmet 10.

The retention system is tested with a free-fall drop test of a 10 kg (22.0 lb.) weight from a height of 0.75 m (29.5 in.) attached to the fastened chin strap. No more than 35 mm (1.37 in.) displacement of the attachment point is allowed.

The chin strap buckle system is also tested for slippage under load, and the strap material itself is tested for abrasion resistance and tension failure load (which cannot be less than 3 kN or 674.4 lb.). There are also tests for ease of release and durability of quick-release buckle systems.

There are some areas where the DOT and ECE standards differ, for example, the surface of the helmet 10 is tested for abrasion resistance but in this test the performance standard requires that the helmet 10 surface either shear away or allow the test surface to slip past the helmet 10. This is to minimize the amount of twisting force the helmet 10 would transmit to the wearer's head and neck. Projections from the helmet 10 (snaps, rivets, etc.) may not exceed 2 mm.

Another test assesses the rigidity of the shell of the helmet 10 by measuring the deformation of the helmet 10 shell when progressively more load is applied up to 630 Newton's (141.6 lb.).

In addition to these areas, ECE 22.05 includes a performance for the visor on a helmet 10, if it is an integral part of the helmet 10. DOT provides standards for visors and other eye protection gear in a separate standard referred to as VESC 8 (Vehicle Equipment Safety Commission). The ECE standards do not include a test for penetration resistance.

The ECE standard includes requirements for retroreflective materials that may apply in specific member countries.

Unlike the DOT system, where the product is not subject to third-party testing prior to sale, the ECE system required batch sampling when production begins, submission of up to 50 sample helmets/visors to a designated laboratory working for the government that uses the ECE standards under the United Nations agreement and verification of quality control during on-going production.

The ECE standard specifies which type or configuration of helmet 10 the approval applies to, using the following codes: “J” if the helmet 10 does not have a lower face 12 cover, “P” if the helmet 10 has a protective lower face 12 cover, or “NP” if the helmet 10 has a non-protective lower face 12 cover, (stated as ECE 22.05J, ECE 22.05P or ECE 22.05NP).

Snell (Snell Memorial Foundation M2010) Helmet 10 Standard:

Once development is completed, manufacturers seeking certification submit sample helmets to Snell for testing using the Foundation's standardized tests. If the helmet 10 passes all the tests, it will receive certification under the standard (currently designated M2010) and the manufacturer can label the helmet 10 as Snell certified.

Once a given model design is certified, it cannot be altered in production. Post-marketing random testing is also conducted by the Foundation to verify continued compliance. Failure during random testing can lead to de-certification of the helmet 10.

Snell certification is voluntary and is not required by federal or international authorities, but may be required by some competition sanctioning bodies.

Snell Foundation testing evaluates each helmet 10 model in four areas and specifications for pre-test environmental conditioning of helmets are used. As with the other two systems, 105° of peripheral vision from the midline is required.

Impact absorption testing is done in similar fashion to ECE and DOT, using a free-fall drop test from a fixed height with a head form in the helmet 10 to measure impact energy transferred to the interior of the helmet 10 when dropped onto a fixed anvil.

Five different anvil shapes are used in the testing. The peak acceleration energy allowed is 300 G, though the peak acceleration allowed depends on the test and most are somewhat lower.

The height the helmet 10 is dropped from varies; the velocity reached by the impact point is what is specified in the test specifications, ranging from about five to nearly eight meters per second for certification tests.

The protection provided by the helmet 10 shell from penetration is tested by dropping a 3 kg (6.6 lb.) pointed striker on the helmet 10 from a height of 3 m (9.8 ft.). The helmet 10 fails the test if the striker penetrates the helmet 10 shell making contact with the head form.

Full face 12 helmets are tested for strength of the chin bar by mounting the helmet 10 chin bar facing up in a jig and dropping a 5 kg (11 lb.) weight onto the chin bar midpoint from a fixed height and measuring the amount of deflection the impact causes. Deflection of 60 mm (2.3 in.) or more or failure of the chin bar likely to result in injury to the wearer means failure of the test.

FIG. 1 is a view of a helmet 10 containing the safety features provided by the most preferred example of the present invention.

In accordance with the present invention, there exists a helmet 10 designed for riding conveyances such as motorcycles, ATV's, UTV's, Snowmobiles, boats, bicycles and other conveyances where the rider may or may not be completely enclosed. But where the riders rear helmet 10 may be seen by those following in similar or dissimilar conveyances. The helmet 10 is general constructed to fit the head of a human head adult or child with a certain size and other modifications to adapt to the particular wearer but being generally the same as all human heads.

Various materials can be used to create a helmet 10 and the type of material used affects various aspects of that helmet 10. We will now describe some of the preferred materials but understand we are not limiting the present invention to these materials. Any rigid yet impact resistant material suitable for helmet 10 production may be utilized in the present invention. We merely list several examples her to provide the reader with a better understanding of the goals and purpose and how those may be adjusted to meet various needs. A helmet 10 made of: a shell, a foam layer, and padding. The shell disperses the impact across a wide area while also preventing anything from piercing the helmet 10. Meanwhile, the foam absorbs as much of the impact as possible, so your head doesn't have to. Lastly, the soft padding ensures a good fit against your head.

The difference between basic and advanced helmets normally lies in the shell. In contrast, a wide variety of helmets will employ very similar foam layers. Most use some variation of EPS—expanded polystyrene foam. This stuff is stiff and lightweight, but also perfectly crushable during impact. Some advanced helmets will use multiple densities of EPS in various layers and locations. This creates a smarter helmet 10, which can absorb the crash differently depending on the severity and location of impact. Thermoplastic Shells.

Thermoplastic is exactly what it sounds like—hot plastic. That means it can be poured into a mold and cooled into a solid shell. The plastic is usually some form of polycarbonate, which isn't the hardest material out there. So, these helmets require more foam padding to meet safety standards. For this reason, thermoplastic helmets are larger and heavier than more advanced helmets. However, they are also cheap and easy to make. This is, therefore, the cheapest option.

Fiberglass shells are more expensive than plastic, mainly because they're a pain in the butt to make. You have to place fiber cloth inside a mold, add a resin, and then heat everything to a billion degrees. Then, you repeat this process over and over to achieve a weave pattern.

At the end of all this, you have a shell that is harder and more lightweight than plastic. It also has a good impact flexibility, which spreads the force over a wider area of EPS foam. Fiberglass is quite brittle and prone to cracking. So, you'll have to be extra careful not to drop one of these helmets. However, a crackling helmet 10 is great in a crash, because the shell will absorb much of the force before the foam layer even comes into play. So, fiberglass helmets don't require as much foam padding, making them smaller and lighter than plastic lids.

Advanced Fiberglass Shells: These are similar to fiberglass shells. However, they are made from advanced fibers that have already been mixed with a resin or some other substance. So, there's often no need for multiple layering steps. The manufacturing process is, therefore, simplified, which results in a perfect material balance. The result is a helmet 10 with all the same safety features as regular fiberglass, at about 80% the weight.

Kevlar and Carbon Composite Shells: A Kevlar shell has some distinct benefits. The process is the same as with fiberglass but, instead of using fiber cloth or Aramid, manufacturers use Kevlar. And since Kevlar is strong, you don't need to use as many fibers to achieve the same result. So, Kevlar composite shells can be about 20% lighter than fiberglass shells.

Notice the word composite? It's there because Kevlar—which has an awesome tensile strength—kind of blows in terms of compression strength. So, helmets always combine Kevlar with some other material to make up for its shortcomings. Most often, you'll see carbon fiber filling this role. Carbon fiber is super strong and lightweight. It's also very expensive, but since Kevlar isn't cheap to begin with, who cares? The result is a top-of-the-line shell, which achieves the safety standards of fiberglass and plastic helmets with much less size and weight.

The important thing to remember is that advanced materials do not imply advanced safety; a plastic lid can be just as safe as some space-age helmet 10. The difference is that the plastic model uses more volume and weight to achieve the same results. If you're going down, there won't be much difference between the two. When you're riding, however, your neck will thank you for a lighter helmet 10.

By the very nature of a safety helmet 10, the standards will vary according to the purpose, such as require fire retardant in racing but not other fields, a country where it is being used and so forth. Because of these varying standards and requirements, the present invention must remain flexible in its construction and materials, therefore, no one specific material or standard is claimed. To further demonstrate the validity of this, claim the DOT and UK standards have been listed here in part as well as who and how helmets are tested and certified:

DOT, ECE 22.05 & Snell Motorcycle Helmet 10 Standards.

There are more than the three standards that we'll cover here, hut these are the ones you are most likely to see: DOT, ECE 22.05 and Snell.

We don't assume that one standard is superior to any of the others; rather the purpose is to show how the standards compare and where they apply. These motorcycle helmet 10 standards are not mutually exclusive; some helmets are certified to multiple standards.

Following is an explanation of each helmet 10 standard.

DOT Helmet 10 Standard:

This stands for “Department of Transportation,” is FMVSS 218, the Federal Motor Vehicle Safety Standard #218, Motorcycle Helmets, and it is applicable to helmets sold in the U.S. for on-road use.

The National Highway Safety Administration (NHTSA) enforcement authority of the DOT certification requirement applies to helmets intended for on-road use though using a certified helmet 10 for off-road purposes or in competition is certainly a good idea.

NHTSA does not test helmets against the DOT standards before they can claim DOT certification; rather, each helmet 10 manufacturer marketing their helmets for road use in the U.S. must test and self-certify the models they want to sell and then permanently affix the “DOT” emblem signifying compliance with FMVSS 218.

NHTSA enforces the standard by acquiring random samples of the product and sending them to an independent testing lab to verify compliance. Penalties to manufacturers for marketing non-compliant products can be steep-up to $5,000 per helmet 10.

FMVSS 218 sets standards in three areas of helmet 10 performance: impact attenuation, basically energy absorption; penetration resistance; and finally, the retention system effectiveness, and there are new product labeling requirements.

The standard also requires peripheral vision to be not less than 105° from the helmet 10 midline. Projections from the surface of the helmet 10 (snaps, rivets, etc.) may not exceed 5 mm.

The impact test measures acceleration of a head form inside the helmet 10 when it is dropped from a fixed height onto a spherical and flat surfaced anvil. The standard allows a peak acceleration energy of 400 G (G being “gravity constant” or an acceleration value of ft. per second x seconds).

The penetration test involves dropping a piercing test striker onto the helmet 10 from a fixed height. The striker must not penetrate deep enough to contact the head form.

The retention system test involves placing the helmet's retention straps under load in tension. For this test the load is progressive; first, a load of 22.7 kg (49.9 lb.) is applied for 30 seconds, then it is increased to 136 kg (299.2 lb.) for 120 seconds, with measurement of the stretch or displacement of a fixed point on the retention strap from the apex of the helmet 10.

The apparatus for testing a helmet 10 retention system under DOT (FMVSS 218) standards.

ECE 22.05 Helmet 10 Standard:

ECE stands for “Economic Commission for Europe,” which was created under a United Nations agreement in 1958. The 22.05 part refers to the specific regulation that the standards for testing are described in.

The ECE standard, which is accepted in 47 countries, is similar to the DOT standard in several ways, for example: like the DOT standard, peripheral vision through an arc of 105° from the helmet 10 midline is required. Also, environmental conditioning of helmets to be tested is required similar to the DOT standard and certain labeling requirements apply, as well.

Impact absorption testing is performed in a manner very similar to the DOT standard, involving a drop test from a fixed height on a steel anvil with a head form-fitted inside to measure the energy transmitted. Peak acceleration energy at the head form allowed to pass the test is 275 G. Impact absorption and rotational forces are also tested at points where any surfaces or parts project from the shell of the helmet 10.

The retention system is tested with a free-fall drop test of a 10 kg (22.0 lb) weight from a height of 0.75 m (29.5 in.) attached to the fastened chin strap. No more than 35 mm (1.37 in.) displacement of the attachment point is allowed.

The chin strap buckle system is also tested for slippage under load, and the strap material itself is tested for abrasion resistance and tension failure load (which cannot be less than 3 kN or 674.4 lb.). There are also tests for ease of release and durability of quick-release buckle systems.

There are some areas where the DOT and ECE standards differ, for example, the surface of the helmet 10 is tested for abrasion resistance but in this test the performance standard requires that the helmet 10 surface either shear away or allow the test surface to slip past the helmet 10. This is to minimize the amount of twisting force the helmet 10 would transmit to the wearer's head and neck. Projections from the helmet 10 (snaps, rivets, etc.) may not exceed 2 mm.

Another test assesses the rigidity of the shell of the helmet 10 by measuring the deformation of the helmet 10 shell when progressively more load is applied up to 630 Newton's (141.6 lb.).

In addition to these areas, ECE 22.05 includes a performance for the visor on a helmet 10, if it is an integral part of the helmet 10. DOT provides standards for visors and other eye protection gear in a separate standard referred to as VESC 8 (Vehicle Equipment Safety Commission). The ECE standards do not include a test for penetration resistance.

The ECE standard includes requirements for retroreflective materials that may apply in specific member countries.

Unlike the DOT system, where the product is not subject to third-party testing prior to sale, the ECE system required batch sampling when production begins, submission of up to 50 sample helmets/visors to a designated laboratory working for the government that uses the ECE standards under the United Nations agreement and verification of quality control during on-going production.

The ECE standard specifies which type or configuration of helmet 10 the approval applies to, using the following codes: “J” if the helmet 10 does not have a lower face 12 cover, “P” if the helmet 10 has a protective lower face 12 cover, or “NP” if the helmet 10 has a non-protective lower face 12 cover, (stated as ECE 22.05J, ECE 22.05P or ECE 22.05NP).

Snell (Snell Memorial Foundation M2010) Helmet 10 Standard:

Once development is completed, manufacturers seeking certification submit sample helmets to Snell for testing using the Foundation's standardized tests. If the helmet 10 passes all the tests, it will receive certification under the standard (currently designated M2010) and the manufacturer can label the helmet 10 as Snell certified.

Once a given model design is certified, it cannot be altered in production. Post-marketing random testing is also conducted by the Foundation to verify continued compliance. Failure during random testing can lead to de-certification of the helmet 10.

Snell certification is voluntary and is not required by federal or international authorities, but may be required by some competition sanctioning bodies.

Snell Foundation testing evaluates each helmet 10 model in four areas and specifications for pre-test environmental conditioning of helmets are used. As with the other two systems, 105° of peripheral vision from the midline is required.

Impact absorption testing is done in similar fashion to ECE and DOT, using a free-fall drop test from a fixed height with a head form in the helmet 10 to measure impact energy transferred to the interior of the helmet 10 when dropped onto a fixed anvil.

Five different anvil shapes are used in the testing. The peak acceleration energy allowed is 300 G, though the peak acceleration allowed depends on the test and most are somewhat lower.

The height the helmet 10 is dropped from varies; the velocity reached by the impact point is what is specified in the test specifications, ranging from about five to nearly eight meters per second for certification tests.

The protection provided by the helmet 10 shell from penetration is tested by dropping a 3 kg (6.6 lb.) pointed striker on the helmet 10 from a height of 3 m (9.8 ft.). The helmet 10 fails the test if the striker penetrates the helmet 10 shell making contact with the head form.

Full face 12 helmets are tested for strength of the chin bar by mounting the helmet 10 chin bar facing up in a jig and dropping a 5 kg (11 lb.) weight onto the chin bar midpoint from a fixed height and measuring the amount of deflection the impact causes. Deflection of 60 mm (2.3 in.) or more or failure of the chin bar likely to result in injury to the wearer means failure of the test.

Positional stability or “roll-off” is tested using a 4 kg (8.8 lb.) weight attached to first rear edge of the helmet 10 by a cord with the helmet 10 positioned and properly strapped on a head form facing downward at a 135° angle such that when the weight is released, it would tend to try to dislodge the helmet 10 from its correct position on the head form. Then the helmet 10 is rotated 180°, the weight is attached to the front edge of the helmet 10 opening and the test repeated. Failure occurs if the helmet 10 rolls off the head form.

The retention system is tested by first applying a 23 kg (50.6 lb.) tension load to the fastened chin strap for one minute, then simultaneously removing that load and imparting a 38 kg (83.6 lb.) guided fall load to the closed strap system. Breakage or deflection of the strap in excess of 30 mm results in failure of the test.

The face 12 shield, if applicable, is tested for penetration resistance by being shot in three spots along the centerline with an air rifle using a pointed lead pellet at a velocity of approximately 500 kph.

Penetration of the shield means failure and for racing helmets, any bump raised by the impact on the inside surface of the shield cannot exceed 2.5 mm in height.

Flame resistance is also tested under Snell standards, but only for specific types of racing helmets.

As recognized in the prior statements the present invention may meet one or more of these standards.

In a preferred embodiment of the present invention, helmets meeting these varying manufacturing methods and standards will be equipped with a high-powered LED light bar assembly activated by a G force motion sensor 26 such as the ADXL362, a complete 3-axis MEMS acceleration measurement system that operates at extremely low power consumption levels. It measures both dynamic accelerations, resulting from motion or shock, and static acceleration, such as tilt. It's easy to communicate with the ADXL362 over SPI and built-in digital logic even enables autonomous operation for “wake-on-shake” operation. This is an example of a G-Force indicator but not the only possibility.

This G force motion sensor 26 will intelligently determine if the rider is slowing stopping or just moving their head and differentiate between these movements and then activate the high powered high powered LED bar 30 accordingly. To explain this activation further we will break it down into types. The G force motion sensor 26 understands that normal movement of the rider's head is not a reason to activate the high powered high powered LED bar 30. To do so would provide a false indication that the rider was slowing or stopping and soon be ignored by a person following the rider. Therefore, the G force motion sensor 26 must be programmable to avoid false warnings. In the second example if a rider is simply slowing the follower will have more time to react than if the rider is stopping quickly such as in an emergency. In the case of simply slowing the high energy, high powered LED bar 30 may be equipped with an intermediary display, for example, where one-half of the LED's illuminate or where the LED's only partly eliminate in an attempt to indicate a slowing rather than stopping action. In the third example, the G-force indicator sensing an abrupt or fast stop or slowing may illuminate all of the LED's or aluminate them to a brighter display by applying greater electrical energy to them thus indicating to the following rider to avoid or stop quickly.

In the preferred embodiment of the present invention, the helmet 10 may be equipped with a battery pack 28, a solar charger or a combination of either. There should be at least one LED on the high-powered LED bar 30 but there is no limit nor is there any limitation on where they are placed as long as at least one is placed in the rear of the helmet 10. In another preferred embodiment of the present invention, the high-powered LED bar 30 may be extended in purpose to provide what is commonly known as a running light, which is a light that indicates the existence of a conveyance but at a dimmer lumen output than a brake or stopping light would illuminate. The purpose of all of these lights is safety and while the stopping indicator light is of vital importance it should be understood that a stopping light alone does not provide as good of a safety feature as a stopping and running light combination. Even though many conveyances are equipped with both a stopping and running light they are often low and obstructed by terrain, vegetation, and other conditions. The elevated location provided by the rider's helmet 10 increase the visibility and safety tremendously there for we do not limit the scope of this present invention and include the ability to place lights on the helmet 10 in other locations in accordance with the spirit of the present invention. Programming of the G Force motion sensor 26 through the LED light control panel 32 can permit any combination of lights and effect. For example, the Led may put out low lumens while traveling at a steady rate, changing to blinking the LED as rapid slowing occurs and then high brightness as stopping occurs or any variation that suits the needs or regulations of use.

The present invention permits the addition of the high-powered LED bar 30 to existing helmets through an add-on feature called a logo cover 14 that allows for this high-powered LED bar 30 unit to be removably attached by means of logo cover screw 20 to a logo cover screw receiver 18 or permanently by means of an adhesive or other, attached to an existing helmet 10. The add-on unit is self-contained unit consisting of a high-powered LED bar 30, G force motion sensor 26, energy supply. A waterproof rubber gasket 16 that seals the unit and a logo cover 14 that encloses the unit.

The G force motion sensor 26, LED light control panel 32 and battery pack 28 are attached under the logo cover 14 by means of a fastener such as an allen screw 22 securely held in place by means of a allen screw receiver 21.

The logo cover 14 consists of a shroud capable of enclosing the G force motion sensor 26, LED light control panel 32 and battery pack 28 and on the opposing side offers a location for a logo 34 which may be covered by a clear plastic 24 or similar protective coating to maintain the visual integrity of the logo 34.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An intelligent lighted safety helmet for creating a helmet that will warn following riders of the forward rider's actions though a visible speed and stop indicator, comprising:
means for prevent moisture from gaining access to the brake control panel;
means for providing a place for the screws to attach;
means for attaching the logo cover to the helmet;
means for sensing the g force and though this sensing deciding if the brake light should be activated;
means for providing a warning that a rider is ahead and when and if he or she is stopping; and
means for programming the parameters to what activates the LED light bar. this circuit board is the brain of the helmet capable of dictating a multitude of combinations to suit the circumstances.

2. The intelligent lighted safety helmet in accordance with claim 1, wherein said means for <purpose> comprises a logo cover.

3. The intelligent lighted safety helmet in accordance with claim 1, wherein said means for prevent moisture from gaining access to the brake control panel comprises a flexible, sealable waterproof rubber gasket.

4. The intelligent lighted safety helmet in accordance with claim 1, wherein said means for providing a place for the screws to attach comprises a logo cover screw receiver.

5. The intelligent lighted safety helmet in accordance with claim 1, wherein said means for attaching the logo cover to the helmet comprises a fastenable logo cover screw.

6. The intelligent lighted safety helmet in accordance with claim 1, wherein said means for sensing the g force and though this sensing deciding if the brake light should be activated comprises a g force motion sensor.

7. The intelligent lighted safety helmet in accordance with claim 1, wherein said means for providing a warning that a rider is ahead and when and if he or she is stopping comprises a high-powered LED bar.

8. The intelligent lighted safety helmet in accordance with claim 1, wherein said means for programming the parameters to what activates the LED light bar. this circuit board is the brain of the helmet capable of dictating a multitude of combinations to suit the circumstances comprises an LED light control panel.

9. An intelligent lighted safety helmet for creating a helmet that will warn following riders of the forward rider's actions though a visible speed and stop indicator, comprising:
a logo cover, for <purpose>;
a flexible, sealable waterproof rubber gasket, for prevent moisture from gaining access to the brake control panel;
a logo cover screw receiver, for providing a place for the screws to attach;
a fastenable logo cover screw, for attaching the logo cover to the helmet;
a g force motion sensor, for sensing the g force and though this sensing deciding if the brake light should be activated;
a high-powered LED bar, for providing a warning that a rider is ahead and when and if he or she is stopping; and
an LED light control panel, for programming the parameters to what activates the LED light bar. this circuit board is the brain of the helmet capable of dictating a multitude of combinations to suit the circumstances.

10. The intelligent lighted safety helmet as recited in claim 9, further comprising:
a battery pack, for providing power to the g force sensor.

11. An intelligent lighted safety helmet for creating a helmet that will warn following riders of the forward rider's actions though a visible speed and stop indicator, comprising:
a logo cover, for <purpose>;
a flexible, sealable waterproof rubber gasket, for prevent moisture from gaining access to the brake control panel;
a logo cover screw receiver, for providing a place for the screws to attach;
a fastenable logo cover screw, for attaching the logo cover to the helmet;
a g force motion sensor, for sensing the g force and though this sensing deciding if the brake light should be activated;
a battery pack, for providing power to the g force sensor;
a high-powered LED bar, for providing a warning that a rider is ahead and when and if he or she is stopping; and
an LED light control panel, for programming the parameters to what activates the LED light bar. this circuit board is the brain of the helmet capable of dictating a multitude of combinations to suit the circumstances.
